(19) United States
(12) Patent Application Publication
(10) Pub. No.: US 2025/0003636 A1
(43) Pub. Date: Jan. 2, 2025

(54) CONTROLLING THE OPERATION OF GAS FURNACES EQUIPPED WITHSECONDARY ELECTRICAL POWER SOURCE(S)

(71) Applicant: Carrier Corporation, Palm Beach Gardens, FL (US)

(72) Inventors: Paul Haydock, Zionsville, IN (US); Duane Garloch, Westfield, IN (US); Ahmed Hasan, Indianapolis, IN (US); David King, Brownsburg, IN (US)

(21) Appl. No.: 18/743,101

(22) Filed: Jun. 14, 2024

Related U.S. Application Data
(60) Provisional application No. 63/511,397, filed on Jun. 30, 2023.

(51) Int. Cl. F24H 15/108; F24H 15/407; G05D 23/19

(52) U.S. Cl. CPC F24H 15/108; F24H 15/407; G05D 23/1919

(57) ABSTRACT

A method for controlling the operation of a gas furnace equipped with one or more secondary electrical power sources is disclosed. The method comprises the steps of switching the gas furnace to a secondary power mode in an event of loss of a primary electrical power source associated with the gas furnace, wherein the gas furnace alternately switches between an ON state for a first prolonged time, and an OFF state for a second prolonged time, at a frequency of an optimized number of cycles per hour.

### CROSS-REFERENCE TO RELATED APPLICATION

This patent application claims the benefit of U.S. Provisional Patent Application No. 63/511,397, filed on Jun. 30, 2023, which is incorporated by reference herein in its entirety.

### BACKGROUND

This invention relates to the field of gas furnaces, and more particularly, a method and control device for controlling the operation of gas furnaces equipped with secondary electrical power sources.

A residential gas furnace is typically connected to a permanent electrical power source that may also provide electrical power to a building where the gas furnace is installed. The gas furnace may have the capability to operate with either the main power supply of the building or a secondary power source such as a battery and/or self-powered device. The gas furnace may detect loss of the main power supply and may then run on the battery. However, the battery may quickly drain out and the gas furnace may stop operating after some time, which may be inconvenient for occupants of the building.

### SUMMARY

The foregoing summary is illustrative only and is not intended to be in any way limiting. In addition to the illustrative aspects, embodiments, and features described above, further aspects, embodiments, features, and techniques of the invention will become more apparent from the following description taken in conjunction with the drawings.

Described herein is a method for controlling operation of a gas furnace equipped with one or more secondary electrical power sources. The method comprises the steps of switching the gas furnace to a secondary power mode in an event of loss of a primary electrical power source associated with the gas furnace, wherein the gas furnace alternately switches between an ON state for a first prolonged time, and an OFF state for a second prolonged time, at a frequency of an optimized number of cycles per hour.

In one or more embodiments, the one or more secondary electrical power sources comprise a battery and a thermoelectric generator, wherein the method comprises the steps of enabling the thermoelectric generator to generate electrical power from heat generated by the gas furnace during the ON state, and charging the battery and/or operating the gas furnace using the electrical power generated by the thermoelectric generator.

In one or more embodiments, the one or more secondary electrical power sources comprise a battery and a solar power generation system, wherein the method comprises the steps of operating the gas furnace using the solar power generation system during daytime to build and utilize residual heat in an area of interest (AOI) to be heated by the gas furnace.

In one or more embodiments, the one or more secondary electrical power sources comprise a battery, a solar power generation system, and a thermoelectric generator, wherein the method comprises the steps of operating the gas furnace using the solar power generation system during the daytime which enables the thermoelectric generator to generate electrical power from the heat generated by the gas furnace, and operating the gas furnace using the electrical power generated by the thermoelectric generator during the secondary power mode and/or during nighttime.

In one or more embodiments, the gas furnace alternately switches between the ON state and the OFF state based on one or more of characteristics of a thermostat associated with the gas furnace, a thermal load factor, and a thermostat preset temperature to be maintained at an AOI by the gas furnace.

In one or more embodiments, during the secondary power mode, the method comprises the step of keeping the gas furnace in the ON state for the first prolonged time such that the gas furnace remains in the ON state for a longer time period after the preset temperature is achieved at the AOI, to heat the AOI to a first temperature above the preset temperature of the AOI, allowing for bigger temperature swings.

In one or more embodiments, the method further comprises the step of keeping the gas furnace in the OFF state for the second prolonged time once the first temperature is achieved at the AOI, such that the temperature at the AOI drops to a second temperature below the preset temperature of the AOI, allowing for bigger temperature swings.

In one or more embodiments, the length of the cycle which includes the ON state and the OFF state of the gas furnace is longer during the secondary power mode compared to the primary power mode.

In one or more embodiments, during the secondary power mode, the method further comprises steps of adjusting one or more control settings of the gas furnace to conserve electrical power stored in the one or more secondary electrical power sources, wherein the method of adjusting the one or more control settings comprises one or more of adjusting operating speed of a blower associated with the gas furnace to a lowest speed setting with optimized ramp changes during switching ON and OFF of the blower, increasing an ON-delay time of the blower to a first predetermined first value followed by a controlled ramp up of the blower, reducing the OFF-delay time of the blower to a second predetermined value, ending with a controlled ramp down of the blower, and adjusting an input level of the gas furnace to a lowest level.

In one or more embodiments, during the secondary power mode, the method further comprises the steps of switching OFF a thermostat associated with the gas furnace, sensing temperature of return air to the gas furnace, and correspondingly determining a temperature of an area of interest (AOI) to be heated by the gas furnace, wherein the return air is received from the AOI, and controlling the operation of the gas furnace and/or the one or more secondary power sources to maintain a preset temperature at the AOI.

In one or more embodiments, during the secondary power mode, the method further comprises the steps of switching OFF a thermostat associated with the gas furnace, operatively connecting the gas furnace to one or more temperature sensing devices present at the AOI to detect a temperature of the AOI, wherein the one or more temperature sensing devices comprise a low-power wireless sensor, a smart home device, a smart smoke detector, and a smart air purifier, and controlling the operation of the gas furnace and/or the one or more secondary power sources to maintain a preset temperature at the AOI.

Further described herein is a control device for controlling operation of a gas furnace equipped with one or more secondary electrical power sources. The control device comprises a processor coupled to a memory storing instructions executable by the processor, wherein the control device is operatively connected to the gas furnace, a primary electrical power source, and one or more secondary electrical power sources, and wherein the control device is configured to switch the gas furnace to a secondary power mode in an event of loss of the primary electrical power source, wherein the gas furnace alternately switches between an ON state for a first prolonged time, and an OFF state for a second prolonged time, at a frequency of an optimized number of cycles per hour

In one or more embodiments, the control device is a thermostat installed at an area of interest (AOI) to be heated by the gas furnace.

In one or more embodiments, the control device is in communication with a thermostat associated with the gas furnace.

In one or more embodiments, the one or more secondary electrical power sources comprise a battery, and a thermoelectric generator, wherein the control device is configured to: enable the thermoelectric generator to generate electrical power from heat generated by the gas furnace during the ON state; and charge the battery and/or operate the gas furnace using the electrical power generated by the thermoelectric generator.

In one or more embodiments, the one or more secondary electrical power sources comprise a battery, and a solar power generation system, wherein the control device is configured to operate the gas furnace using the solar power generation system during daytime to build and utilize residual heat in an area of interest (AOI) to be heated by the gas furnace.

In one or more embodiments, the one or more secondary electrical power sources comprise one or more of a battery, a solar power generation system, and a thermoelectric generator, wherein the control device is configured to: operate the gas furnace using the solar power generation system during the daytime which enables the thermoelectric generator to generate electrical power from the heat generated by the gas furnace; and operate the gas furnace using the electrical power generated by the thermoelectric generator during the secondary power mode and/or during nighttime.

In one or more embodiments, the control device increases the length of the cycle which includes the ON state and the OFF state based on one or more of characteristics of a thermostat associated with the gas furnace, a thermal load factor, and a thermostat preset temperature to be maintained at an AOI by the gas furnace.

In one or more embodiments, during the secondary power mode, the control device is configured to keep the gas furnace in the ON state for the first prolonged time such that the gas furnace remains in the ON state for a longer time period after the preset temperature is achieved at the AOI, to heat the AOI to a first temperature above the preset temperature of the AOI, allowing for bigger temperature swings.

In one or more embodiments, the control device is configured to keep the gas furnace in the OFF state for the second prolonged time once the first temperature is achieved at the AOI, such that the temperature at the AOI drops to a second temperature below the preset temperature of the AOI, allowing for bigger temperature swings.

In one or more embodiments, the length of the cycle which includes the ON state and the OFF state of the gas furnace, is longer during the secondary power mode compared to the primary power mode.

In one or more embodiments, during the secondary power mode, the control device is configured to adjust one or more control settings of the gas furnace to conserve electrical power stored in the one or more secondary electrical power sources, wherein the adjustment of the one or more control setting comprises one or more of adjusting operating speed of a blower associated with the gas furnace to a lowest speed setting with optimized ramp changes during switching ON and OFF of the blower, increasing an ON-delay time of the blower to a first predetermined first value followed by a controller ramp up of the blower, reducing the OFF-delay time of the blower to a second predetermined value ending with a controller ramp down of the blower, and adjusting an input level of the gas furnace to a lowest level.

In one or more embodiments, during the secondary power mode, the control device is configured to: switch OFF a thermostat associated with the gas furnace; sense temperature of return air to the gas furnace, and correspondingly determine a temperature of an area of interest (AOI) to be heated by the gas furnace, wherein the return air is received from the AOI, control the operation of the gas furnace and/or the one or more secondary power sources to maintain a preset temperature at the AOI.

In one or more embodiments, wherein during the secondary power mode, the control device is configured to: switch OFF a thermostat associated with the gas furnace; operatively connect the gas furnace to one or more temperature sensing devices present at the AOI to detect a temperature of the AOI, wherein the one or more temperature sensing devices comprise a low-power wireless sensor, a smart home device, a smart smoke detector, and a smart air purifier; and control the operation of the gas furnace and/or the one or more secondary power sources to maintain a preset temperature at the AOI.

### BRIEF DESCRIPTION OF THE DRAWINGS

The accompanying drawings are included to provide a further understanding of the subject disclosure of this invention and are incorporated in and constitute a part of this specification. The drawings illustrate exemplary embodiments of the subject disclosure and, together with the description, serve to explain the principles of the subject disclosure.

In the drawings, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary block diagram of a gas furnace equipped with a primary power source and one or more secondary power sources such as a battery, a thermoelectric generator, and a solar power system, where a control device is configured to control the operation of the gas furnace in accordance with one or more embodiments of the disclosure.

FIG. 2 illustrates an exemplary flow diagram of the method for controlling the operation of the gas furnace in accordance with one or more embodiments of the disclosure.

FIGS. 3 to 6 illustrate exemplary temperature vs time graphs depicting variation in the indoor temperature when the control method of FIG. 2 is implemented in the gas furnace at different control parameters.

FIG. 7 illustrates an exemplary cycle per hour vs load factor graph depicting the thermostat response profile for various 50% load factor cycle rates (N50) in accordance with one or more embodiments of the disclosure.

FIG. 8A illustrates an exemplary graph depicting the gas furnace cycle and blower operation during lengthened ON-delay and shortened OFF-delay in accordance with one or more embodiments of the disclosure.

FIG. 8B illustrates an exemplary graph depicting the gas furnace cycle and blower operation during low-speed operation of the blower in accordance with one or more embodiments of the disclosure.

FIG. 8C illustrates an exemplary graph depicting the gas furnace cycle and blower operation during ramped changes in the speed of the blower in accordance with one or more embodiments of the disclosure.

FIG. 8D illustrates an exemplary graph depicting the gas furnace cycle and blower operation during lengthened ON-delay, shortened OFF-delay, and low-speed operation with ramped changes in the speed of the blower in accordance with one or more embodiments of the disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the subject disclosure as defined by the appended claims.

Various terms are used herein. To the extent a term used in a claim is not defined below, it should be given the broadest definition persons in the pertinent art have given that term as reflected in printed publications and issued patents at the time of filing.

In the specification, reference may be made to the spatial relationships between various components and to the spatial orientation of various aspects of components as the devices are depicted in the attached drawings. However, as will be recognized by those skilled in the art after a complete reading of the subject disclosure, the components of this invention. described herein may be positioned in any desired orientation. Thus, the use of terms such as “above,” “below,” “upper,” “lower,” “first”, “second” or other like terms to describe a spatial relationship between various components or to describe the spatial orientation of aspects of such components should be understood to describe a relative relationship between the components or a spatial orientation of aspects of such components, respectively, as the gas furnace, thermoelectric generator, battery, control device, thermostat, and corresponding components, described herein may be oriented in any desired direction.

Existing gas-fired forced hot air furnace “gas furnace” can operate either with the main electrical power supply of the building where the gas furnace is located or by a secondary power source such as a battery. A gas furnace additionally utilizes a thermoelectric generator, but is not limited to the like, as one of the secondary power sources which is configured in the path of the hot combusted gas generated by the gas furnace. The combusted gas (combustion products) flows through the pipes of a heat exchanger to an exhaust which leads to the chimney or direct vent in the building.

If the main power supply to the gas furnace or building is interrupted, as may occur during storms or fault conditions, the gas furnace continues to run using the battery. However, the battery may quickly drain out and the gas furnace may stop or fail after some time, which may be inconvenient for occupants of the building and may also lead to the failure of the gas furnace. There is, therefore, a need to provide an improved and power-efficient control strategy for controlling the operation of the gas furnace equipped with secondary power sources, especially in an event of loss of the main power supply.

This invention provides a method (control strategy) and a control device for efficient and longer operation of the gas furnace using the battery and additional secondary power sources in the event of loss of the main power supply.

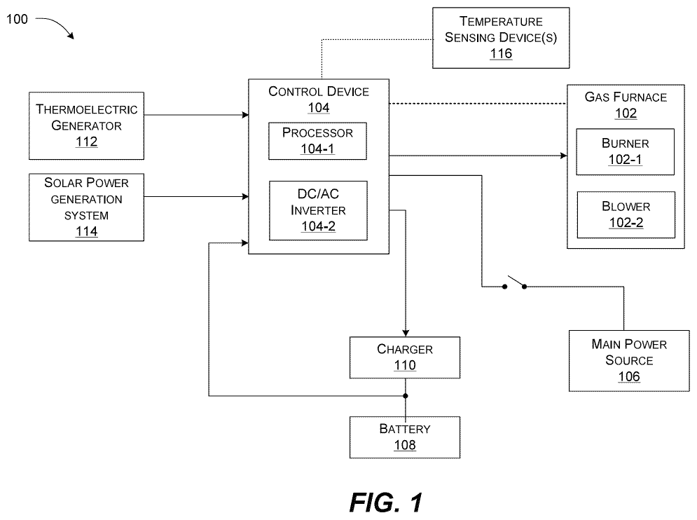

Referring to FIG. 1, in one or more embodiments, the gas furnace 102 comprises a burner 102-1 to generate heat or combustion gases and a blower 102-2 to direct the generated heat to the desired locations. The gas furnace 102 is operated through a control device 104 using the electrical power supplied by a main (primary) electrical power source/supply 106. The gas furnace 102 and the control device 104 are operatively connected to one or more secondary power sources such as a rechargeable battery 108, a thermoelectric generator 112, a solar power system 114, and a wind power system, but not limited to the like. The thermoelectric generator 112 remains in thermal connection with the gas furnace 102. The rechargeable battery 108 may be electrically connected to the blower 102-2 and the thermoelectric generator 112 as already explained in detail in the above paragraphs. A temperature sensing device 116 may be operably connected to the control device 104. The control device 104 may be configured to demand heat from the gas furnace 102 according to methods explained herein and depending on the power source(s) available.

The output electrical terminals of the battery 108, the thermoelectric generator 112, and the solar power system 114 are operatively connected to the control device 104 that controls one or more operations of the gas furnace 102. The control device 104 includes a processor 104-1 coupled to a memory storing instructions executable by the processor 104-1 to enable the control device 104 to perform one or more designated operations. The control device 104 further includes a switch gear and a DC to AC inverter 104-2, which inverts the DC (current) from the thermoelectric generator 112 or the solar power system 114 into AC (current) for charging the battery 108 or for operating the blower motor 102-2 of the gas furnace 102. Further, the control device 104 may supply DC (current) from the thermoelectric generator 112 or the solar power system 114 to the battery 108 and/or the blower motor 102-2 of the gas furnace 102. Furthermore, the control device 104 may also supply AC (current) from primary electrical power source 106 to the battery 108 and/or the blower motor 102-2 of the gas furnace. However, the electrical attributes (amplitude, frequency, and/or phase difference, but not limited to the like) of the AC or DC (current) supplied to the battery and/or the blower motor 102-2 may be adjusted as per the ratings of the battery 108 and/or the blower motor 102-2 In one or more embodiments, the control device 104 may be a thermostat of the gas furnace 102, which may be programmed and/or configured with additional components to perform the designated operations of the control device 104, however, in other embodiments, the control device 104 may be a standalone device that may be operatively connected to the thermostat of the gas furnace 102, and the thermoelectric generator 112 and the battery 108.

The inverter 104-2 of the control device 104 is further connected to a battery charger 110 that charges the battery 108 associated with the gas furnace 102. The battery 108 is connected back to the control device 104 and the switch gear connects the battery 108 to the blower motor 102-2 upon starting the burner 102-1 of the gas furnace 102. When the gas furnace 102 is in operation, the burner 102-1 may be fired to generate heat and the blower 102-2 may receive electrical power from the main electrical power source 106 to create an airflow to direct the generated heat to an area of interest (AOI) such as a building where the gas furnace 102 is located or to be heated. The same primary electrical power source 106 may also supply electrical power to the AOI/building. The control device 104 further connects the thermoelectric generator 112, and/or the solar power system 114 to the battery charger 110 and/or the battery 108, such that the thermoelectric current generated by the thermoelectric generator 112 using the heat generated in the gas furnace 102, is supplied, after DC to AC inversion, to the charger 110 so that the battery 108 may be charged. Similarly, the electrical power generated by the solar power system is supplied, after DC to AC inversion, to charger 110 so that the battery 108 may be charged.

In one or more embodiments, the control device 104 is configured to detect the loss of the primary electrical power supply 106 associated with the gas furnace 102. The control device 104 is configured to operatively connect the gas furnace 102 to one or more of the thermoelectric generator 112, the solar power system 114, and/or battery 108 in the event of loss of the primary electrical power supply 106.

In one or more embodiments, in the event of loss of the primary electrical power supply 106, the control device 104 switches the gas furnace 102 to a secondary power mode (also referred to as alternate-power mode, herein), where the gas furnace 102 alternately switches between an ON state for a first prolonged time (also referred to as ON-time, Ton), and an OFF state for a second prolonged time (also referred to as OFF-time, Toff), at a frequency (N) of an optimized number of cycles per hour, operating with higher temperature swings to preserve alternate source power while maintaining thermal comfort. This approach may maximize the heat generated (btu/hr.) per electric energy consumed to run the unit (Watt·hr). The length of the cycle which includes the ON state and OFF state (ON time plus OFF time) of the gas furnace is longer during the secondary power mode than during primary-power mode. It is to be appreciated that adjusting the cycle timing on the gas furnace to increase the temperature swing of the heated space may reduce the number of ON and OFF cycles and thus reduce the electrical system losses associated with cyclic switching of the gas furnace 102. Thus, this may reduce the electrical losses and further facilitate a reduction in the consumption of electrical power from the secondary electrical power sources 108, 112, 114.

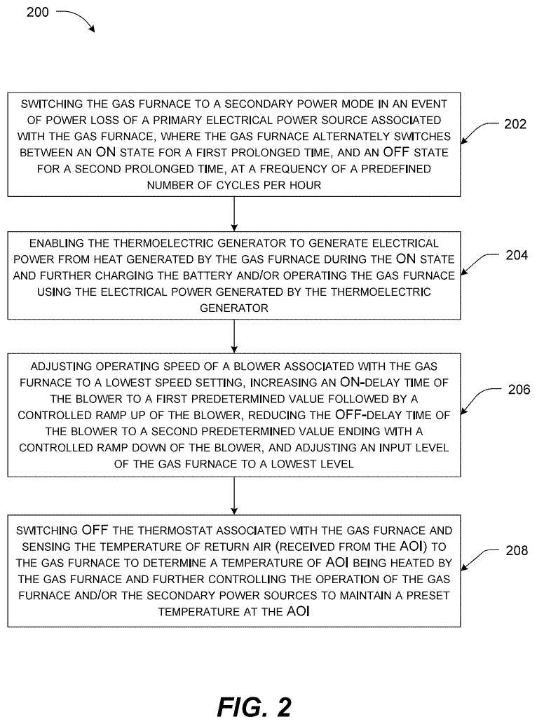

In one or more embodiments, the control device 104 alternately switches the gas furnace 102 between the ON state and the OFF state based on one or more characteristics of a thermostat, comprising a thermal load factor, and a thermostat preset temperature to be maintained at the AOI by the gas furnace 102. This preset temperature may differ from the corresponding temperature during normal (main power) operation. During the secondary power mode, the control device 104 is configured to keep the gas furnace 102 in the ON state for the first prolonged time such that the gas furnace 102 remains in the ON state for a longer time period after the preset temperature is achieved at the AOI, to heat the AOI to a first temperature above the preset temperature of the AOI. Further, the control device 104 is configured to keep the gas furnace 102 in the OFF state for the second prolonged time once the first temperature is achieved at the AOI, such that the temperature at the AOI drops to a second temperature below the preset temperature of the AOI. The detailed operation has been described in detail in conjunction with FIGS. 2 to 7.

The control device 104 further enables the thermoelectric generator 112, the solar power system 114, and/or the battery 108 to supply electrical power to the gas furnace 102 during the secondary power mode. Accordingly, in one or more embodiments, during the secondary power mode, the heat generated by the gas furnace 102 during the ON state enables the thermoelectric generator 112 to generate electrical power that is stored in the battery 108 or may be used to operate the gas furnace 102 directly during the primary power loss. In addition, in other embodiments, the electrical power generated by the solar power system 114 during the daytime may be stored in the battery 108 and/or may be used to operate the gas furnace 102 during the primary power loss and/or during nighttime. This facilitates a reduction in the consumption of electrical power from the battery 108 in the event of loss of the primary power supply 106.

In one or more embodiments, during the secondary power mode, the control device 104 is configured to electrically connect the thermoelectric generator 112 to the battery 108 which enables the thermoelectric generator 112 to generate electrical power from heat generated by the gas furnace 102 during the ON state, and further charge the battery 108 and/or operate the gas furnace 102 using the electrical power generated by the thermoelectric generator 112.

In one or more embodiments, the control device 104 is configured to electrically connect the solar power system 114 to the gas furnace 102 and/or the battery 108 and further operate the gas furnace 102 using the solar power system 114 during the daytime to build and utilize residual heat in AOI to be heated by the gas furnace 102. Further, the control device 104 is configured to operate the gas furnace 102 using the solar power system 114 during the daytime which enables the thermoelectric generator 112 to generate electrical power from the heat generated by the gas furnace 102. The control device 104 further operates the gas furnace 102 using the electrical power generated by the thermoelectric generator 112 during the secondary power mode and/or during nighttime.

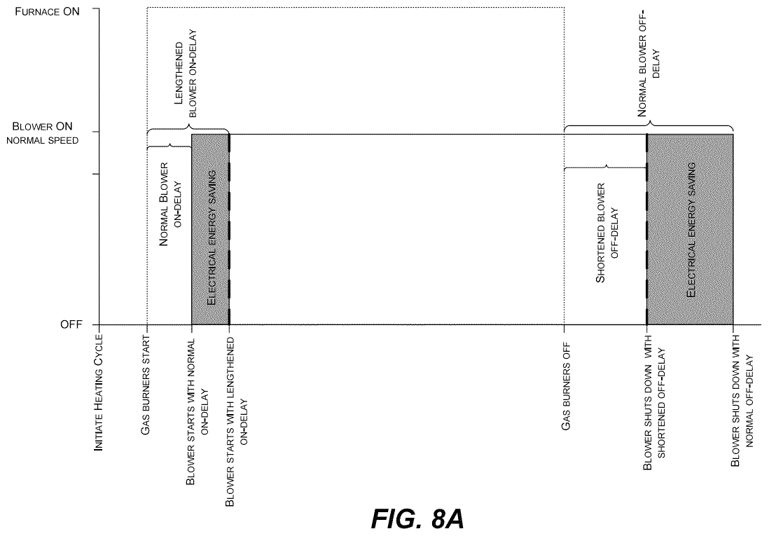

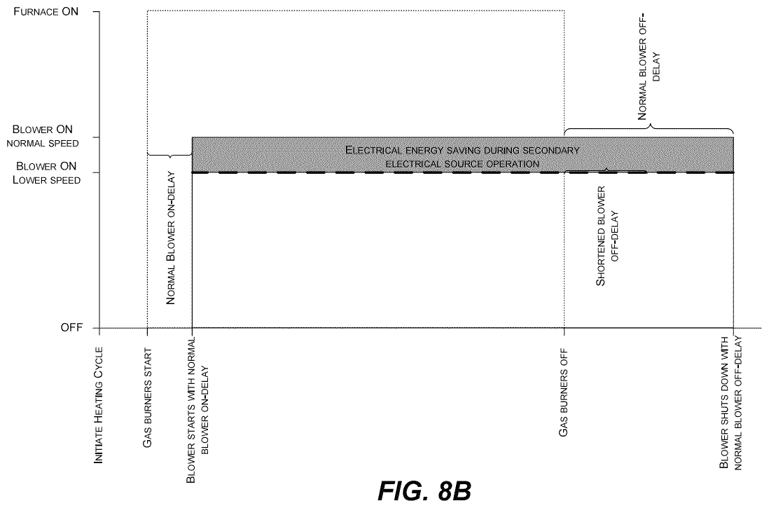

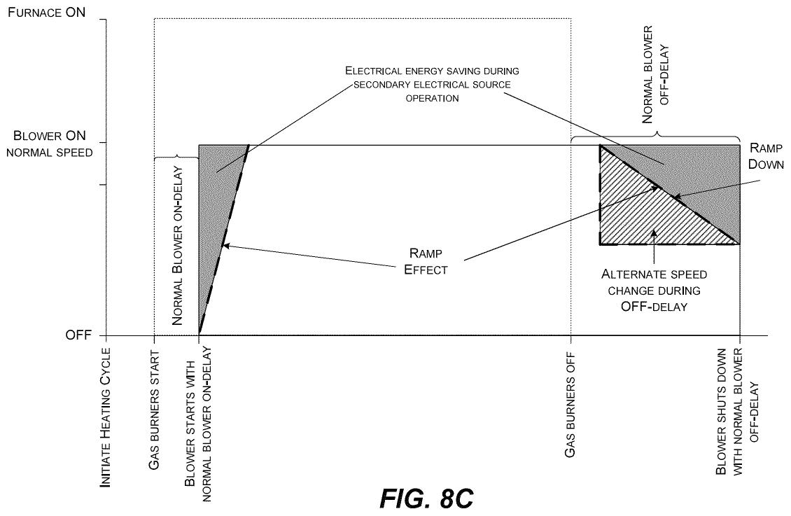

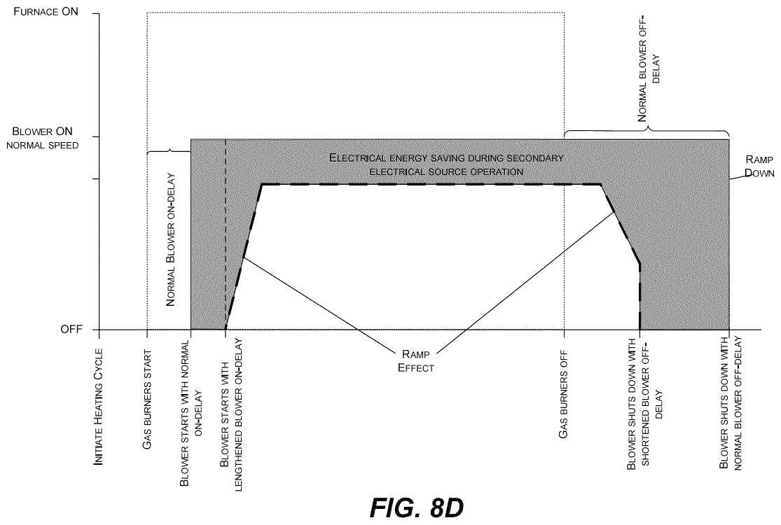

Referring to FIGS. 8A to 8D, in one or more embodiments, during the secondary power mode, the control device 104 is configured to adjust one or more control settings of the gas furnace 102 to conserve electrical power. The control device 104 adjusts the operating speed of the blower 102-1 to the lowest speed setting as shown in FIG. 8A with optimized ramp changes during switching ON and OFF of the blower as shown in FIG. 8C. The control device 104 further increases the ON-delay time of the blower 102-1 to a first predetermined first value followed by a controlled ramp up of the blower and reduces the OFF-delay time of the blower 102-1 to a second predetermined value ending with a controlled ramp down of the blower as shown in FIG. 8C, and adjust the input level of the gas furnace 102 to the lowest level in case the gas furnace is a multi-stage gas furnace. This may help conserve the electrical power of the secondary power sources 108, 112, and 114 while maintaining a comfortable temperature at the AOI.

In one or more embodiments, during the secondary power mode, the control device 104 is configured to switch OFF the thermostat associated with the gas furnace 102 and sense the temperature of return air (received from the AOI) to the gas furnace 102 to determine a temperature of the AOI. The control device 104 may further control the operation of the gas furnace 102 and/or the secondary power sources 108, 112, and 114 to maintain a preset temperature at the AOI as explained in the above paragraphs. As thermostat generally consumes electrical power, the thermostat may be switched off during the secondary power mode to save electrical power, however, the gas furnace 102 or control device 104 keeps monitoring the temperature of the AOI based on the return air received from the AOI and accordingly maintains the preset temperature or a comfortable temperature at the AOI.

Further, during the secondary power mode, the control device 104 is configured to switch OFF the thermostat and operatively connect the gas furnace 102 to one or more temperature sensing devices present at the AOI to detect the temperature of the AOI. In one or more embodiments, the temperature sensing devices may comprise a low-power wireless sensor, a smart home device, a smart smoke detector, and a smart air purifier, but not limited to the like (collectively designated as 116, herein). The control device 104 may further control the operation of the gas furnace 102 and/or the secondary power sources 108, 112, and 114 to maintain a preset temperature or comfortable temperature at the AOI. Thus, the thermostat may be kept switched off during the secondary power mode to save electrical power, while monitoring the temperature of the AOI using the low-power wireless sensor, smart home device, smart smoke detector, and/or smart air purifier of the AOI and the gas furnace 102 further maintaining the preset temperature or comfortable temperature at the AOI.

In one or more embodiments, the temperature sensing device 116 may be a low-power wireless sensor or sensing device that may be located at the AOI and may include an in-built battery (single-use or rechargeable) or may use energy harvesting technologies to transmit feedback of thermal comfort at the AOI to the control device 104. The low-power wireless sensor 116 may be a two-pushbutton wireless device, where the kinetic energy generated by pressing the button is harvested into electrical energy, starting an electronic circuit, and sending a wireless signal to the control device associated with the gas furnace 102. The two buttons may correspond to feelings such as “I am comfortable” or “I am not comfortable”. This feedback can inform the control device 104 that it is too hot, cold, or that temperature swings are too wide at the AOI. The timing of the button pushes may also be used to interpret the intent of the discomfort (ex. before heating comes on=too cold; during heating call=too warm). This may work as a replacement for the power-consuming thermostat, especially during the primary power loss, thereby making the system power-efficient.

In one or more embodiments, the temperature sensing device 116 may be a low power remote temperature sensor 116 that is capable of using very low energy to transmit information about the AOI temperature to the control device. The sensor may be equipped with low energy communication module such as Bluetooth, EnOcean, and the like, which may be plugged into the wall (similar to a wall-plugged flashlight) or be integrated onto the thermostat. The sensor 116 may be powered during the primary power loss. In either case, in the event of primary power loss, the sensor 116 may be activated which can communicate the AOI temperature directly to the control device 104. This enables the control device 104 to know if heating is needed at the AOI and helps to ensure overheating does not occur at the AOI. This allows the control device to optimize the heating cycle of the gas furnace to reduce electrical consumption instead of relying on pre-programmed thermostat cycles which are largely based on comfort.

Referring to FIG. 2, method 200 for controlling the operation of the gas furnace of FIG. 1 includes step 202 switching the gas furnace to a secondary power mode in an event of power loss of a primary electrical power source associated with the gas furnace, where the gas furnace alternately switches between an ON state for a first prolonged time, and an OFF state for a second prolonged time, at a frequency of an optimized number of cycles per hour.

At step 202, during the secondary power mode, the method involves keeping the gas furnace in the ON state for the first prolonged time (Ton) such that the gas furnace remains in the ON state for a longer time period after the preset temperature is achieved at the AOI, to heat the AOI to a first temperature above the preset temperature of the AOI. At step 202, method 200 further involves the step of keeping the gas furnace in the OFF state for the second prolonged time (Toff) once the first temperature is reached at the AOI, such that the temperature at the AOI drops to a second temperature below the preset temperature of the AOI. In one or more embodiments, the length of the cycle which includes the ON state and the OFF state (ON time plus OFF time) is longer during the secondary power mode than during primary-power mode. During the secondary power mode (loss of primary power supply 106), it is beneficial for the gas furnace to remain on (active heating) for a longer duration so that the thermoelectric generator has time to achieve maximum utilization and thereby minimize the use of the battery reserves. The thermostat typically maintains a preset temperature at the AOI/building to optimize comfort with low bands of temperature swings. However, in the secondary power mode of this invention, after the control device/thermostat becomes satisfied (i.e., a preset indoor temperature is achieved in the AOI/building, the control device allows the gas furnace to remain in the ON state for a longer period, which slightly overshoots the AOI temperature above the preset indoor temperature but in a comfortable temperature range for the occupants, however, this facilitates minimizing the draining of the battery power. Moreover, adjusting the cycle timing on the gas furnace to increase the temperature swing of the heated space may reduce the number of ON and OFF cycles, thereby reducing the electrical system losses associated with cyclic switching of the gas furnace. Thus, this may reduce the electrical losses and further facilitate a reduction in the consumption of electrical power from the secondary electrical power sources and the battery.

The control device alternately switches the gas furnace between the ON state and the OFF state for a frequency (N) of an optimized number of cycles per hour based on a load factor (LF). The load factor (LF) is the fraction of the capacity of the gas furnace being utilized by the control device for maintaining a desired temperature at the AOI/building, which is calculated based on the outdoor design temperature (T_{D}), the average outdoor air temperature (T_{OA}), zero load temperature (T_{O}), and an oversize factor (α). For instance, at zero load outdoor temperature (T_{O}), the load factor is zero (0). Further, at the point where the gas furnace 102 is operated at its full capacity, the load factor is one (1).

The load factor is calculated using the conventional equation,

$$LF ≅ \frac{{T}_{0} - {T}_{OA}}{( {T}_{0} - {T}_{D} ) ( 1 + α )} ,$$

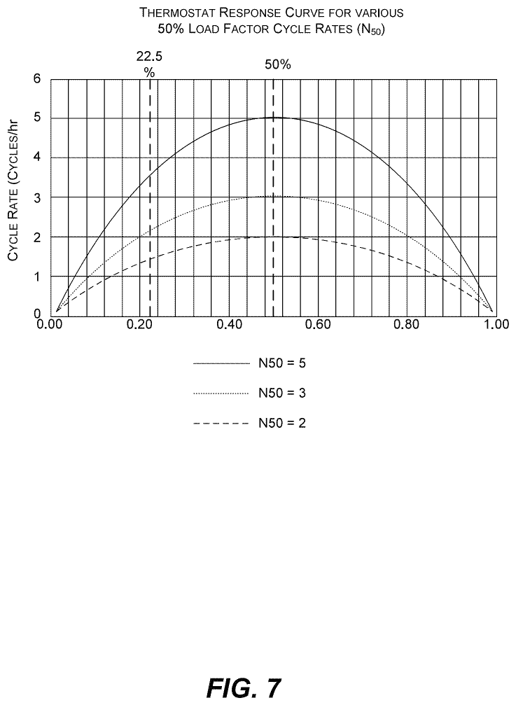

Further, the cycle per hour (N) may be accordingly selected using a thermostat response profile for various 50% load factor cycle rates (N50) ranging from but not limited to 2 to 5 as shown in FIG. 7.

Further, the ON-time (T_{ON}) is determined using the conventional equation,

$${T}_{ON} ≅ \frac{60 \times LF}{Cycle Rate ( C R )} ,$$

and the OFF-time (T_{OFF}) is determined using the conventional equation

$${T}_{OFF} ≅ \frac{60}{Cycle Rate ( C R )} - {T}_{ON} ,$$

where the thermostat load factor cycle rate, CR=4N₅₀(LF)(1-LF).

In one or more embodiments, the gas furnace alternately switches between the ON state and the OFF state based on one or more of the characteristics of a thermostat associated with the gas furnace, which comprises a thermal load factor, and a thermostat preset temperature to be maintained at an AOI by the gas furnace.

In one or more embodiments, during the secondary power mode, the method includes step 204 of enabling the thermoelectric generator to generate electrical power from heat generated by the gas furnace during the ON state and further charging the battery and/or operating the gas furnace using the electrical power generated by the thermoelectric generator. Further, in some embodiments, the method includes the steps of operating the gas furnace using the solar power generation system during the daytime to build and utilize residual heat in the AOI. Furthermore, in other embodiments, the method includes the steps of operating the gas furnace using the solar power generation system during the daytime which enables the thermoelectric generator to generate electrical power from the heat generated by the gas furnace and further operate the gas furnace using the electrical power generated by the thermoelectric generator during the secondary power mode and/or during nighttime. Accordingly, the electrical power generated by the solar power system during the daytime may be stored in the battery and/or may be used to operate the gas furnace during the primary power loss and/or during the nighttime. This facilitates a reduction in the consumption of electrical power from the battery in the event of loss of the primary power supply.

In one or more embodiments, during the secondary power mode, the method further includes step 206 of adjusting one or more control settings of the gas furnace to conserve electrical power stored in the one or more secondary electrical power sources. The step 206 of adjusting the one or more control settings comprises one or more of adjusting the operating speed of the blower associated with the gas furnace to the lowest speed setting with optimized ramp changes during switching ON and OFF of the blower, increasing an ON-delay time of the blower to a first predetermined first value followed by a controlled ramp up of the blower, reducing the OFF-delay time of the blower to a second predetermined value ending with a controlled ramp down of the blower, and adjusting an input level of the gas furnace to the lowest level. This may help conserve the electrical power of the secondary power sources while maintaining a comfortable temperature at the AOI.

In one or more embodiments, during the secondary power mode, the method further comprises step 208 of switching OFF the thermostat associated with the gas furnace and sensing the temperature of return air (received from the AOI) to the gas furnace to determine a temperature of AOI being heated by the gas furnace and further controlling the operation of the gas furnace and/or the secondary power sources to maintain a preset temperature at the AOI. During step 208, keeping the thermostat switched off during the secondary power mode may save electrical power, however, the gas furnace or control device may keep monitoring the temperature of the AOI based on the return air received from the AOI and further maintain the preset temperature or a comfortable temperature at the AOI

In one or more embodiments, during the secondary power mode, the method further comprises step 208 of switching OFF the thermostat and operatively connecting the gas furnace to one or more temperature sensing devices present at the AOI or using other appropriate low energy sensors within the AOI itself to detect a temperature of the AOI being heated by the gas furnace and further controlling the operation of the gas furnace and/or the one or more secondary power sources to maintain a preset temperature at the AOI. Thus, the thermostat may be kept switched off during the secondary power mode to save electrical power, while monitoring the temperature of the AOI using the low-power wireless sensor, smart home device, smart smoke detector, and/or smart air purifier of the AOI and the gas furnace further maintaining the preset temperature or a comfortable temperature at the AOI

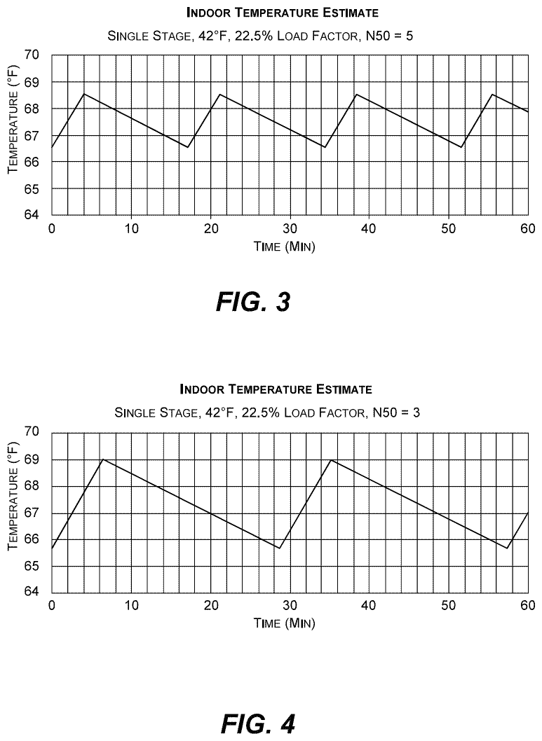

Referring to FIGS. 3 to 6, exemplary temperature vs time graphs depicting variation in the indoor temperature when the control method of FIG. 2 is implemented in the gas furnace using the control device of FIG. 1 at different control parameters are illustrated. In an example, for an average outdoor temperature (T_{OA}) of 42° F. (5.6° C.), outdoor design temperature (T_{D}) of 5° F. (−15° C.), zero load temperature (T_{O}) of 65° F. (18.3° C.), oversize factor (α) of 0.70, thermostat cycle rate (CR) at half load (i.e., when the outdoor temperature on the AOI is at 50% of the design condition for the AOI/building), the Load factor is about 0.225.

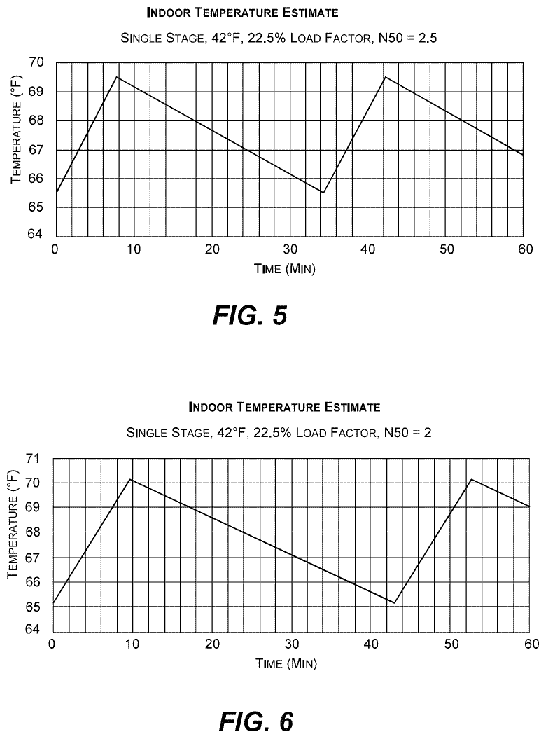

In one or more embodiments, as illustrated in FIG. 3, at LF of 0.225 (22.5%) and N50 of 5 cycles per hour, the T_{ON} is determined to be 3.87 min and the T_{OFF} is determined to be 13.3 min with a temperature swing of ±1° F. In one or more embodiments, as illustrated in FIG. 4, at a LF of 22.5% and N50 of 3 cycles per hour, the T_{ON} is determined to be 6.45 min and the T_{OFF} is determined to be 22.2 min with a temperature swing of ±1.66° F. In one or more embodiments, as illustrated in FIG. 5, at a LF of 22.5% and N50 of 2.5 cycles per hour, the T_{ON} is determined to be 7.74 min and the T_{OFF} is determined to be 26.6 min with a temperature swing of ±2° F. In one or more embodiments, as illustrated in FIG. 6, at a LF of 22.5% and N50 of 2 cycles per hour, the T_{ON} is determined to be 9.68 min and the T_{OFF} is determined to be 33.3 min with a temperature swing of ±2.25° F.

During the secondary (alternate) power mode, the control device 104 keeps the gas furnace 102 in the ON state for the T_{On} time such that the gas furnace 102 remains in the ON state for a longer period after the preset indoor temperature is achieved at the AOI, to heat the AOI to a first temperature (1 to 1.25° F. above the preset temperature of the AOI). Further, the control device 104 keeps the gas furnace 102 in the OFF state for T_{OFF} time once the first temperature is reached at the AOI, such that the temperature at the AOI drops to a second temperature (1 to 1.25° F. below the preset temperature of the AOI, thereby providing a minimal temperature swing at the AOI/building.

It should be obvious to a person skilled in the art that while various embodiments and examples of this invention have been elaborated for operating the gas furnace in the secondary (alternate) power mode at 22.5% load factor, frequency of 3 to 5 cycles per hour, and 50% load factor cycle rate for the sake of simplicity and better explanation purpose considering an outdoor temperature of 42° F., however, the teachings of this invention are equally applicable for other values of load factors, turn ON and turn OFF time, frequencies, and load factor cycle rate depending on the outside temperature and design temperature of the building/AOI, and all such embodiments are well within the scope of this invention.

Thus, the method (control strategy) and control device of this invention overcome the drawback, shortcomings, and limitations associated with existing gas furnaces by enabling efficient and longer operation of the gas furnace using the battery and/or the secondary power sources in an event of loss of the main power supply, with a minimal temperature swing at the AOI/building.

While the invention has been described with reference to exemplary embodiments, it will be understood by those skilled in the art that various changes may be made and equivalents may be substituted for elements thereof without departing from the scope of the invention as defined by the appended claims. Modifications may be made to adopt a particular situation or material to the teachings of the invention without departing from the scope thereof. Therefore, it is intended that the invention not be limited to the particular embodiment disclosed, but that the invention includes all embodiments falling within the scope of the invention as defined by the appended claims.

In interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

Without excluding further possible embodiments, certain example embodiments are summarized in the following clauses:

Clause 1. The control device of any of the preceding clauses, wherein the length of the cycle which includes the ON state and the OFF state of the gas furnace, is longer during the secondary power mode compared to the primary power mode.
Clause 2. The control device of any of the preceding clauses, wherein during the secondary power mode, the control device is configured to adjust one or more control settings of the gas furnace to conserve electrical power stored in the one or more secondary electrical power sources, wherein the adjustment of the one or more control setting comprises one or more of adjusting operating speed of a blower associated with the gas furnace to a lowest speed setting with optimized ramp changes during switching ON and OFF of the blower, increasing an ON-delay time of the blower to a first predetermined first value followed by a controller ramp up of the blower, reducing the OFF-delay time of the blower to a second predetermined value ending with a controller ramp down of the blower, and adjusting an input level of the gas furnace to a lowest level.
Clause 3. The control device of any of the preceding clauses, wherein during the secondary power mode, the control device is configured to: switch OFF a thermostat associated with the gas furnace; sense temperature of return air to the gas furnace and correspondingly determine a temperature of an area of interest (AOI) to be heated by the gas furnace, wherein the return air is received from the AOI, and control the operation of the gas furnace and/or the one or more secondary power sources to maintain a preset temperature at the AOI.
Clause 4. The control device of any of the preceding clauses, wherein during the secondary power mode, the control device is configured to: switch OFF a thermostat associated with the gas furnace; operatively connect the gas furnace to one or more temperature sensing devices present at the AOI to detect a temperature of the AOI, wherein the one or more temperature sensing devices comprise a low-power wireless sensor, a smart home device, a smart smoke detector, and a smart air purifier, and control the operation of the gas furnace and/or the one or more secondary power sources to maintain a preset temperature at the AOI.

1. A method for controlling operation of a gas furnace equipped with one or more secondary electrical power sources, the method comprising the steps of:
switching the gas furnace to a secondary power mode in an event of loss of a primary electrical power source associated with the gas furnace, wherein the gas furnace alternately switches between an ON state for a first prolonged time, and an OFF state for a second prolonged time, at a frequency of an optimized number of cycles per hour.

2. The method of claim 1, wherein the one or more secondary electrical power sources comprise a battery and a thermoelectric generator, wherein the method comprises the steps of:
enabling the thermoelectric generator to generate electrical power from heat generated by the gas furnace during the ON state; and
charging the battery and/or operating the gas furnace using the electrical power generated by the thermoelectric generator.

3. The method of claim 1, wherein the one or more secondary electrical power sources comprise a battery and a solar power generation system, wherein the method comprises the steps of operating the gas furnace using the solar power generation system during daytime to build and utilize residual heat in an area of interest (AOI) to be heated by the gas furnace.

4. The method of claim 1, wherein the one or more secondary electrical power sources comprise a battery, a solar power generation system, and a thermoelectric generator, wherein the method comprises the steps of:
operating the gas furnace using the solar power generation system during the daytime which enables the thermoelectric generator to generate electrical power from the heat generated by the gas furnace; and
operating the gas furnace using the electrical power generated by the thermoelectric generator during the secondary power mode and/or during nighttime.

5. The method of claim 1, wherein the gas furnace alternately switches between the ON state and the OFF state based on one or more of characteristics of a thermostat associated with the gas furnace, a thermal load factor, and a thermostat preset temperature to be maintained at an AOI by the gas furnace.

6. The method of claim 1, wherein during the secondary power mode, the method comprises the step of keeping the gas furnace in the ON state for the first prolonged time such that the gas furnace remains in the ON state for a longer time period after the preset temperature is achieved at the AOI, to heat the AOI to a first temperature above the preset temperature of the AOI, allowing for bigger temperature swings.

7. The method of claim 6, wherein the method further comprises the step of keeping the gas furnace in the OFF state for the second prolonged time once the first temperature is achieved at the AOI, such that the temperature at the AOI drops to a second temperature below the preset temperature of the AOI, allowing for bigger temperature swings.

8. The method of claim 1, wherein the length of the cycle which includes the ON state and the OFF state of the gas furnace is longer during the secondary power mode than during the primary-power mode.

9. The method of claim 1, wherein during the secondary power mode, the method further comprises steps of adjusting one or more control settings of the gas furnace to conserve electrical power stored in the one or more secondary electrical power sources,
wherein the method of adjusting the one or more control settings comprises one or more of adjusting operating speed of a blower associated with the gas furnace to a lowest speed setting with optimized ramp changes during switching ON and OFF of the blower, increasing an ON-delay time of the blower to a first predetermined first value followed by a controlled ramp up of the blower, reducing the OFF-delay time of the blower to a second predetermined value ending with a controlled ramp down of the blower, and adjusting an input level of the gas furnace to a lowest level.

10. The method of claim 1, wherein during the secondary power mode, the method further comprises the steps of:
switching OFF a thermostat associated with the gas furnace;
sensing temperature of return air to the gas furnace and correspondingly determining a temperature of an area of interest (AOI) to be heated by the gas furnace, wherein the return air is received from the AOI, and
controlling the operation of the gas furnace and/or the one or more secondary power sources to maintain a preset temperature at the AOI.

11. The method of claim 1, wherein during the secondary power mode, the method further comprises the steps of:
switching OFF a thermostat associated with the gas furnace;
operatively connecting the gas furnace to one or more temperature sensing devices present at the AOI to detect a temperature of the AOI, wherein the one or more temperature sensing devices comprise a low-power wireless sensor, a smart home device, a smart smoke detector, and a smart air purifier; and
controlling the operation of the gas furnace and/or the one or more secondary power sources to maintain a preset temperature at the AOI.

12. A control device for controlling operation of a gas furnace equipped with one or more secondary electrical power sources, the control device comprises:
a processor coupled to a memory storing instructions executable by the processor,
wherein the control device is operatively connected to the gas furnace, a primary electrical power source, and one or more secondary electrical power sources, and
wherein the control device is configured to switch the gas furnace to a secondary power mode in an event of loss of the primary electrical power source, wherein the gas furnace alternately switches between an ON state for a first prolonged time, and an OFF state for a second prolonged time, at a frequency of an optimized number of cycles per hour.

13. The control device of claim 12, wherein the control device is a thermostat installed at an area of interest (AOI) to be heated by the gas furnace.

14. The control device of claim 12, wherein the control device is in communication with a thermostat associated with the gas furnace.

15. The control device of claim 12, wherein the one or more secondary electrical power sources comprise a battery, and a thermoelectric generator, wherein the control device is configured to:
enable the thermoelectric generator to generate electrical power from heat generated by the gas furnace during the ON state; and
charge the battery and/or operate the gas furnace using the electrical power generated by the thermoelectric generator.

16. The control device of claim 12, wherein the one or more secondary electrical power sources comprise a battery, and a solar power generation system, wherein the control device is configured to operate the gas furnace using the solar power generation system during daytime to build and utilize residual heat in an area of interest (AOI) to be heated by the gas furnace.

17. The control device of claim 12, wherein the one or more secondary electrical power sources comprise one or more of a battery, a solar power s generation system, and a thermoelectric generator, wherein the control device is configured to:
operate the gas furnace using the solar power generation system during the daytime which enables the thermoelectric generator to generate electrical power from the heat generated by the gas furnace; and
operate the gas furnace using the electrical power generated by the thermoelectric generator during the secondary power mode and/or during nighttime.

18. The control device of claim 12, wherein the control device increases the length of the cycle which includes the ON state and the OFF state based on one or more of characteristics of a thermostat associated with the gas furnace, a thermal load factor, and a thermostat preset temperature to be maintained at an AOI by the gas furnace.

19. The control device of claim 12, wherein during the secondary power mode, the control device is configured to keep the gas furnace in the ON state for the first prolonged time such that the gas furnace remains in the ON state for a longer time period after the preset temperature is achieved at the AOI, to heat the AOI to a first temperature above the preset temperature of the AOI, allowing for bigger temperature swings.

20. The control device of claim 19, wherein the control device is configured to keep the gas furnace in the OFF state for the second prolonged time once the first temperature is achieved at the AOI, such that the temperature at the AOI drops to a second temperature below the preset temperature of the AOI, allowing for bigger temperature swings.
